(19) United States
(12) Patent Application Publication
(10) Pub. No.: US 2005/0216700 A1
(43) Pub. Date: Sep. 29, 2005

(54) Reconfigurable parallelism architecture

(76) Inventors: Hooman Honary, Newport Coast, CA (US); Inching Chen, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/813,790

(22) Filed: Mar. 26, 2004

(51) Int. Cl. G06F 15/00

(52) U.S. Cl. 712/15

(57) ABSTRACT

Method and apparatus to perform reconfigurable parallel processing are described.

### BACKGROUND

Computer architectures may use parallel processing to reduce the clock rate needed for processing applications with high compute requirements. Some parallel processing systems, however, are static and may not dynamically change in response to different processes or devices.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 illustrates a block diagram of a system 100;

FIG. 2 illustrates a block diagram of a system 200;

FIG. 3 illustrates a block diagram of a system 300;

FIG. 4 illustrates a block diagram of a system 400; and

FIG. 5 illustrates a flow diagram for configurable logic 500.

### DESCRIPTION OF SPECIFIC EMBODIMENTS

Numerous specific details may be set forth herein to provide a thorough understanding of the embodiments. It will be understood by those skilled in the art, however, that the embodiments may be practiced without these specific details. In other instances, well-known methods, procedures, components and circuits have not been described in detail so as not to obscure the embodiments. It can be appreciated that the specific structural and functional details disclosed herein may be representative and do not necessarily limit the scope of the embodiments.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

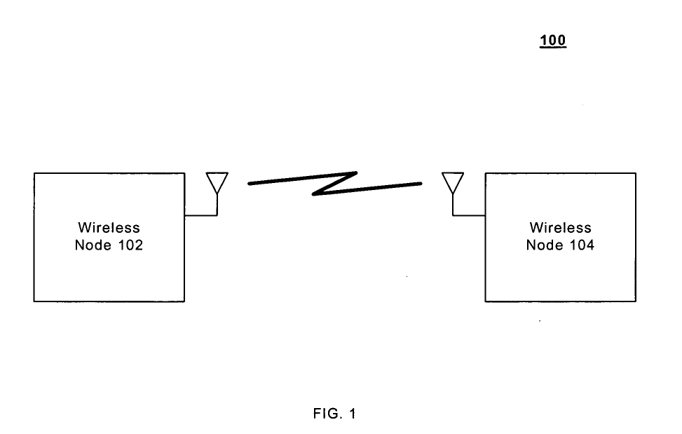

Referring now in detail to the drawings wherein like parts are designated by like reference numerals throughout, there is illustrated in FIG. 1 a system suitable for practicing one embodiment. FIG. 1 is a block diagram of a system 100. System 100 may comprise a plurality of nodes. The term “node” as used herein may refer any element, module, component, board, device or system that may process a signal representing information. The signal may be, for example, an electrical signal, optical signal, acoustical signal, chemical signal, and so forth. The embodiments are not limited in this context.

System 100 may comprise a plurality of nodes connected by varying types of communications media. The term “communications media” as used herein may refer to any medium capable of carrying information signals. Examples of communications media may include metal leads, semiconductor material, twisted-pair wire, co-axial cable, fiber optic, radio frequency (RF) spectrum, and so forth. The terms “connection” or “interconnection,” and variations thereof, in this context may refer to physical connections and/or logical connections. The nodes may connect to the communications media using one or more input/output (I/O) adapters, such as a network interface card (NIC), for example. An I/O adapter may be configured to operate with any suitable technique for controlling communication signals between computer or network devices using a desired set of communications protocols, services and operating procedures, for example. The I/O adapter may also include the appropriate physical connectors to connect the I/O adapter with a suitable communications medium.

In one embodiment, for example, system 100 may be implemented as a wireless system having a plurality of nodes using RF spectrum to communicate information, such as a cellular or mobile system. In this case, one or more nodes shown in system 100 may further comprise the appropriate devices and interfaces to communicate information signals over the designated RF spectrum. Examples of such devices and interfaces may include omni-directional antennas and wireless RF transceivers. The embodiments are not limited in this context.

The nodes of system 100 may be configured to communicate different types of information. For example, one type of information may comprise “media information.” Media information may refer to any data representing content meant for a user, such as data from a voice conversation, videoconference, streaming video, electronic mail (“email”) message, voice mail message, alphanumeric symbols, graphics, image, video, text and so forth. Another type of information may comprise “control information.” Control information may refer to any data representing commands, instructions or control words meant for an automated system. For example, control information may be used to route media information through a system, or instruct a node to process the media information in a predetermined manner. The embodiments are not limited in this context.

The nodes of system 100 may communicate the media or control information in accordance with one or more protocols. The term “protocol” as used herein may refer to a set of instructions to control how the information is communicated over the communications medium. The protocol may be defined by one or more protocol standards, such as the standards promulgated by the Internet Engineering Task Force (IETF), International Telecommunications Union (ITU), a company such as Intel® Corporation, and so forth.

As shown in FIG. 1, system 100 may comprise a wireless communication system having a wireless node 102 and a wireless node 104. Wireless nodes 102 and 104 may comprise nodes configured to communicate information over a wireless communication medium, such as RF spectrum. Wireless nodes 102 and 104 may comprise any wireless device or system, such as mobile or cellular telephone, a computer equipped with a wireless access card or modem, a handheld client device such as a wireless personal digital assistant (PDA), a wireless access point, a base station, a mobile subscriber center, and so forth. In one embodiment, for example, wireless node 102 and/or wireless node 104 may comprise wireless devices developed in accordance with the Personal Internet Client Architecture (PCA) by Intel® Corporation. Although FIG. 1 shows a limited number of nodes, it can be appreciated that any number of nodes may be used in system 100. Further, although the embodiments may be illustrated in the context of a wireless system, the principles discussed herein may also be implemented in a wired communication system as well. The embodiments are not limited in this context.

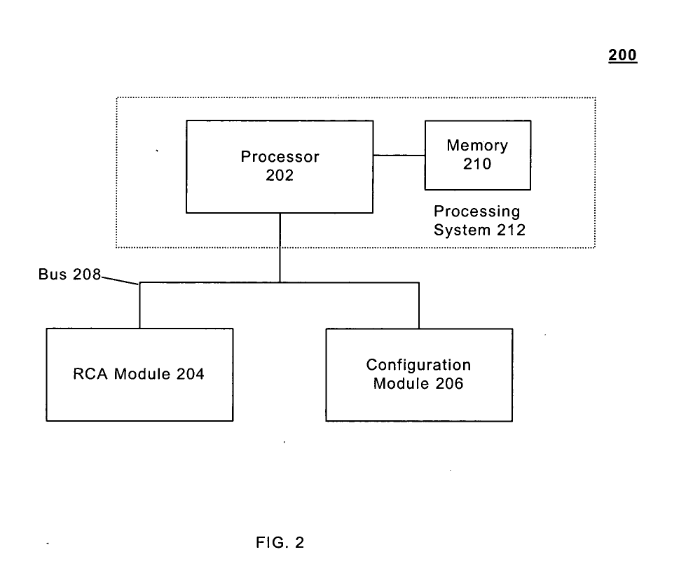

FIG. 2 illustrates a block diagram of a system 200 in accordance with one embodiment. System 200 may be implemented as part of, for example, wireless nodes 102 and/or 104. As shown in FIG. 2, system 200 may comprise a processing system 212, a reconfigurable communications architecture (RCA) module 204, and a configuration module 206, all connected via a communications bus 208. Processing system 212 may further comprise a processor 202 and a memory 210. Although FIG. 2 shows a limited number of modules, it can be appreciated that any number of modules may be used in system 200.

In one embodiment, processing system 212 may be any processing system on the host system, such as in wireless nodes 102 and/or 104. Processing system 212 may comprise processor 202. Processor 202 may comprise any type of processor capable of providing the speed and functionality suitable for the embodiments of the invention. For example, processor 202 could be a processor made by Intel Corporation and others. Processor 202 may also comprise a digital signal processor (DSP) and accompanying architecture. Processor 202 may further comprise a dedicated processor such as a network processor, embedded processor, micro-controller, controller, input/output (I/O) processor (IOP), and so forth. The embodiments are not limited in this context.

In one embodiment, processing system 212 may comprise memory 210. Memory 210 may comprise a machine-readable medium and accompanying memory controllers or interfaces. The machine-readable medium may include any medium capable of storing instructions and data adapted to be executed by processor 202. Some examples of such media include, but are not limited to, read-only memory (ROM), random-access memory (RAM), programmable ROM, erasable programmable ROM, electronically erasable programmable ROM, double data rate (DDR) memory, dynamic RAM (DRAM), synchronous DRAM (SDRAM), embedded flash memory, and any other media that may store digital information.

In one embodiment, system 200 may comprise RCA module 204. RCA module 204 may be a reconfigurable system. A reconfigurable system may comprise a combination of hardware and software that may be configured to execute different types of applications. An example of a suitable reconfigurable system may be an RCA system as developed by Intel Corporation, for example.

Reconfigurable systems have resulted from an increasing demand for high-performance computing systems. For example, there is a growing demand for computing devices capable of handling multiple communications protocols, thereby enabling a wireless node to switch seamlessly between any of a variety of communication protocols, such as IEEE 802.11, IEEE 802.16, General Packet Radio Service (GPRS), Enhanced GPRS (EGPRS), Bluetooth, Ultra Wideband (UWB), third generation cellular (3GPP) wideband code division multiple access (WCDMA) spread spectrum, fourth generation cellular (4G), ITU G.992.1 Asymmetrical Digital Subscriber Line (ADSL), ADSL2+, and so forth. Such a capability might, for example, enable a user to maintain a continuous connection to the Internet or a virtual private network (VPN) as the user moved his laptop computer between a cable modem connection in his apartment, to a wireless local area network (WLAN) connection in his apartment complex, to a mobile connection while riding the train to work, to a local area network connection at his office. As another example, the ability to switch between a number of different communication protocols may be useful on a business trip, as a user moves between countries or regions that have adopted different communications standards.

Computer systems typically include a combination of hardware and software, although the relative roles and proportions of each will often vary among systems. Software-based systems typically operate by executing computer-readable instructions on general-purpose hardware. Hardware-based systems, on the other hand, are typically comprised of circuitry specially designed to perform specific operations, such as an application specific integrated circuits (ASIC). As a result, hardware-based systems generally have higher performance than software-based systems, although they also typically lack the flexibility to perform tasks other than the specific task(s) for which they were designed.

Reconfigurable systems represent a hybrid approach, in which design or configuration files are used to reconfigure specially designed hardware to achieve performance approaching that offered by custom hardware. Reconfigurable systems also provide the flexibility of software-based systems, including the ability to adapt to new requirements, protocols, and standards. Thus, for example, a reconfigurable system could be used to efficiently process a variety of communications protocols, without the need for dedicated, ASIC-based digital signal processors (DSPs) for each protocol, resulting in savings in chip-size, cost, and/or power consumption.

In one embodiment, RCA module 204 may comprise multiple execution units used to perform complex calculations. The results generated by one execution unit may be used as input to other execution units, stored in memory, or sent to another processing system. Calculations can be divided among hardware elements, such that different parts of a calculation are assigned to the execution units upon which they are most efficiently carried out. For example, the physical layer processing performed by many wireless and wired communications systems often involves a combination of numerically intensive computations and somewhat less intensive, but more general-purpose, computations. This is particularly true of protocols that use packetized data where fast acquisition is often needed. For example, processing a 802.11a preamble typically entails fast preamble detection, fast automatic gain control (AGC) adjustment, and fast timing synchronization. These computations can advantageously be performed by processors that include a combination of data path execution units capable of efficiently performing the intensive numerical computations, and integer units capable of performing the general purpose computations.

In one embodiment, one or more execution units of RCA module 204 may be configured to perform parallel processing to reduce latency and enhance overall system performance. More particularly, RCA module 204 may be configured to perform single instruction multiple data (SIMD) parallel processing and multiple instruction multiple data (MIMD) parallel processing.

In one embodiment, one or more execution units of RCA module 204 may be configured to perform SIMD processing. SIMED processing may refer to using a single instruction to control multiple processing data paths. Each data path may execute the same operation using multiple pieces of data. This type of parallel processing is typically used for regular repetitive operations, such as finite impulse response (FIR) filtering, multiply-accumulate operations, fast fourier transform (FFT) butterfly processing, and so forth.

In one embodiment, one or more execution units of RCA module 204 may be configured to perform MIMD processing. MIMD processing may occur when each processing data path is controlled by a separate instruction. In MIMD processing, different operations are executed on the data paths. This type of parallel processing is typically used in applications with heterogeneous processing requirements. For example, very long instruction word (VLIW) processors typically employ MIMD processing.

In one embodiment, system 200 may comprise configuration module 206. Configuration module 206 may store configuration information to configure RCA module 204 to process a given application. For example, the configuration information may be used to configure RCA module 204 to perform SIMED processing in a first configuration to execute a first process. In another example, the configuration information may be used to configure RCA module 204 to perform MIMD processing in a second configuration to execute a second process. Although configuration module 206 is shown as a separate module for system 200, it may be appreciated that configuration module 206 may comprise a set of program instructions and data stored in memory 210. The embodiments are not limited in this context.

In general operation, system 200 may be initiated when power is applied to system 200. During the initialization process, processing system 212 may configure RCA module 204 using the configuration information stored as part of configuration module 206. RCA module 204 may then be ready to perform various functions in accordance with the configuration information.

In one embodiment, the configuration of RCA module 204 may be modified to suit a particular application. Such modifications can be made periodically or in accordance with an external driven event. Examples of the latter may include receipt of explicit instructions to reconfigure RCA module 204 issued by a user, application, device, and so forth. The configurability of RCA module 204 may allow RCA module 204 to implement a particular parallel processing technique for a given process. The parallel processing technique may be selected in accordance with a number of different factors, such as throughput speed in terms of Million Instructions Per Second (MIPS), latency times, power requirements, and so forth. RCA module 204 may implement SIMD processing, MIMD processing, or any combination thereof, on a function by function basis.

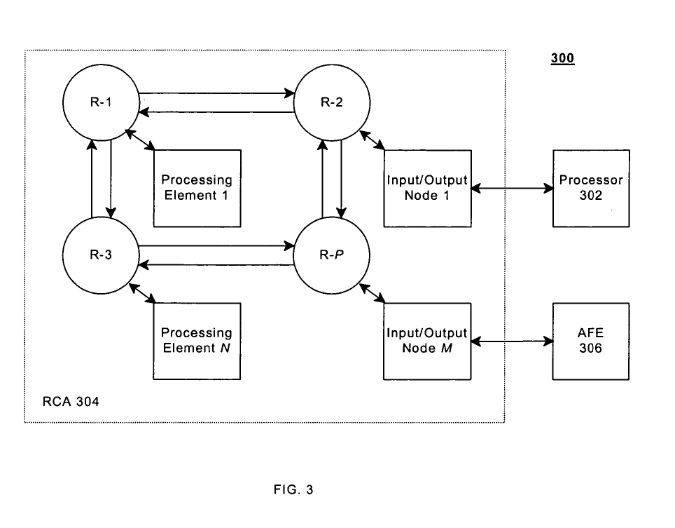

FIG. 3 illustrates a block diagram of a system 300 in accordance with one embodiment. System 300 may comprise a processor 302, an RCA module 304, and an analog front end (AFE) 306. Processor 302 and RCA module 304 may be representative of, for example, processor 202 and RCA module 204, respectively. As shown in FIG. 3, RCA module 304 may comprise multiple processing elements (PE) 1-N, multiple Input/Output (I/O) nodes 1-M, and multiple routing engines (R) 1-P, connected via communications mediums in accordance with any number of different topologies, such as a mesh topology, for example. I/O nodes 1-M may be connected to various external devices, such as processor 302 and AFE 306. Although FIG. 3 shows a limited number of elements, it can be appreciated that any number of elements may be used in system 300.

In one embodiment, RCA 304 may form an infrastructure consisting of a heterogeneous array of flexible accelerators, data-driven control, and a mesh network for providing physical layer (PHY) and lower media access control (MAC) processing. RCA 304 may operate as the digital baseband (PHY layer) and lower MAC (data link layer) elements for a wireless device, such as a software defined radio (SDR), for example. The embodiments are not limited in this context.

In one embodiment, RCA 304 may comprise PE 1-N. PE 1-N may comprise a heterogeneous collection of “coarse” grained processing elements. Each PE is configurable to support multiple protocols, and may be designed to have an area and power approaching that of comparable dedicated hardware components. Each PE uses data-driven control, and may be implemented in accordance with a desired level of reconfigurability and scalability parameters. PE 1-N may be connected in a relatively low latency mesh via routing elements R 1-M that enables the architecture to scale without potentially affecting previous instantiations.

In one embodiment, PE 1-N may be specially tailored to address generic communications applications. As such, PE 1-N may contain a relatively coarse granularity that is specifically addressing front end and back end processing functions, as well as miscellaneous general purpose operations. Although PE 1-N may each be designed to perform different operations, they all share a similar architectural approach that embraces SIMD and/or MIMD parallelism. In addition, they all have execution units that may be optimized through custom design to execute their intended functions while allowing some reasonable flexibility for parameter changes.

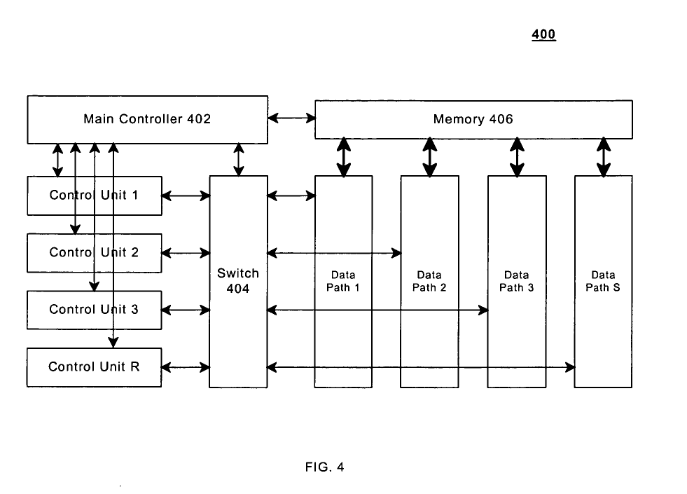

In one embodiment, one or more PE of PE 1-N may be implemented as a general purpose micro-coded accelerator (GPMCA). A GPMCA may be configured to perform a general set of operations, such as matrix inversions, symbol decoding and encoding, descrambling, cyclical redundancy check (CRC) processing, and so forth. Moreover, a PE may be configured to perform parallel processing for such operations, such as SIMD processing, MIMD processing, and so forth. Such a PE may be discussed in more detail with reference to FIG. 4.

In one embodiment, RCA 304 may comprise I/O nodes 1-M. I/O nodes 1-M may operate as an interface with various external devices, such as a processor 302. Processor 302 may comprise, for example, an embedded controller. I/O nodes 1-M may also interface with AFE 306. The embodiments are not limited in this context.

In one embodiment, system 300 may comprise one or more analog RF front end devices, such as AFE 306. For transmissions from wireless nodes 102 and/or 104, AFE 306 may convert digitized baseband samples to RF. Similarly, for received RF signals, AFE 306 may convert the RF band of interest to a digitized baseband. The embodiments are not limited in this context.

In general operation, processor 302 may provide overall control and supervision needed to download the necessary setup information into each PE 1-N and I/O node 1-M, plus any needed setup information for AFE 306. In addition to its control functions, processor 302 may provide the MAC layer functional operations. At each location in the mesh of PE 1-N is a routing engine (R 1-M) that is part of the mesh interconnect. Each PE 1-N is electrically connected to R 1-M. During initialization, processor 302 downloads configuration information and initial contents of data memories to each PE 1-N via the mesh interconnect using configuration data packets. Once all configuration information is downloaded and PE 1-N are initialized, processing operations may begin.

System 300 may perform a number of different functions, such as transmit and receive functions. When performing the transmit function, processor 302 delivers data to PE 1-N for PHY baseband processing. As baseband processing takes place, digitized samples are streamed to one or more AFE 306 for conversion to RF, then transmitted via an attached antenna. For the receive function, AFE 306 receives RF signals from the antenna, converts the RF signal to baseband, and delivers digitized samples to PE 1-N for digital baseband processing. Once processed, digital data is delivered to processor 302 for MAC layer processing.

FIG. 4 illustrates a block diagram of a system 400 in accordance with one embodiment. System 400 may be representative of, for example, a PE such as PE 1-N of system 300. Alternatively, system 400 may be implemented as part of any processing system capable of having reconfigurable hardware and software elements. The embodiments are not limited in this context.

In one embodiment, system 400 may comprise a GPMCA building block responsible for performing operations such as baseband symbol processing for various communications protocols, such as IEEE 802.11, IEEE 802.16, GPRS, EGPRS, Bluetooth, UWB, 3GPP, WCDMA, 4G, ITU G.992.1 ADSL and ADSL2+, and so forth. The type of communication protocol is not limited in this context.

In one embodiment, the symbol processing may need a number of different data paths. System 400 may be configured to suit a given protocol. Further, a different parallel processing structure can be used for different functions within a given protocol. As a result, system 400 may reduce the overall clock and power requirements for a device, such as wireless node 102 and/or 104, for example.

As shown in FIG. 4, system 400 may comprise multiple control units 1-R connected to a switch 404. Control units 1-R and switch 404 may be connected to a main controller 402. Switch 404 may also be connected to data paths (DP) 1-S. DP 1-S may be connected to memory 406. Although FIG. 4 shows a limited number of control units and data paths, it can be appreciated that any given number may be used in system 400 and still fall within the scope of the embodiments.

In one embodiment, system 400 may comprise control units 1-R. The operation of system 400 is controlled by one or more control units 1-R. Each control unit 1-R is configured to send function control signals derived from functions that the control units are executing to the various components of system 400. For example, control unit 1 may send function control signals to DP 1 via switch 404, specifying the operations to be performed on data read from memory 406, for example. In one embodiment, each control unit 1-R sends function control signals representing a single function. Each control unit 1-R may be reconfigurable to accommodate different functions. In one embodiment, the signals used to reconfigure the various DP 1-S may be sent on each clock cycle by a state machine run on one or more control units.

In one embodiment, system 400 may comprise DP 1-S. DP 1-S are generally designed to perform numerically intensive operations, such as those involved in DSP calculations, for example. DP 1-S may be configured to perform their processing in parallel, using SIMD processing or MIMD processing, based on the connections between control units 1-R and DP 1-S. Each data path may be configured with any logic suitable for a desired set of operations. For example, a data path may comprise a multi-input pre-adder, multiplier, an accumulator register, and so forth. In one embodiment, these elements can be reconfigured by a control unit to perform different functions, such fast FFT, filter operations, and so forth.

In one embodiment, system 400 may comprise switch 404. Switch 404 may comprise any switch capable of switching signals between control units 1-R and DP 1-S. The switch controls which control units connect to which DP. The connections allow a control unit to send control signals to the connected DP. The switch may comprise, for example, a cross-bar switch, backplane, and so forth. The embodiments are not limited in this context.

In one embodiment, system 400 may comprise main controller 402. Main controller 402 may receive configuration information from configuration module 206, and configure switch 404 to establish the connections in accordance with a given application. For example, a single control unit (e.g., control unit 1) may be configured to control all four data paths DP 1-S. In this case, main controller 402 may configure switch 404 to connect control unit 1 to DP 1-S to allow control unit 1 to send control signals to DP 1-S. This may be a suitable configuration to perform SIMD processing, for example. In another example, each control unit 1-R may be configured to control a corresponding DP 1-S, respectively. Each control unit 1-R may be able to send control signals only to its respective DP 1-S. This may be a suitable configuration to perform MIMED processing, for example. Any configuration of control units 1-R and DP 1-S may also be implemented. For example, a 2×2 configuration may be configured, with one control unit controlling two data paths, and another control unit controlling the other two data paths. The embodiments are not limited in this context.

In one embodiment, system 400 may comprise memory 406. Memory 406 may comprise any type of memory to store data to be executed by system 400. Memory 406 may accumulate data from other PE in the form of packets. The received data may be stored in memory 406. When the received data is of a sufficient amount to begin processing, control units 1-R begin sending control signals to DP 1-S to begin processing the data.

Operations for the above systems may be further described with reference to the following figures and accompanying examples. Some of the figures may include configurable logic. Although such figures presented herein may include a particular configurable logic, it can be appreciated that the configurable logic merely provides an example of how the general functionality described herein can be implemented. Further, the given configurable logic does not necessarily have to be executed in the order presented unless otherwise indicated. In addition, although the given configurable logic may be described herein as being implemented in the above-referenced modules, it can be appreciated that the configurable logic may be implemented anywhere within the system and still fall within the scope of the embodiments.

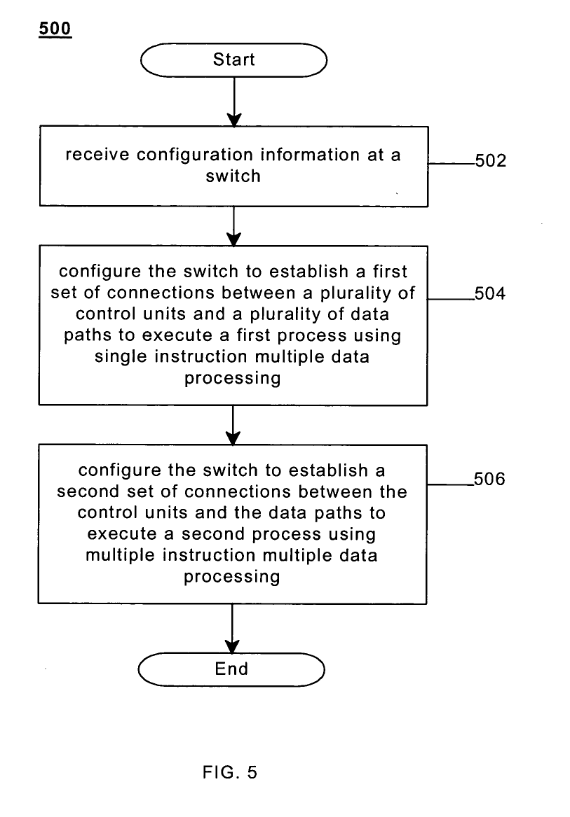

FIG. 5 illustrates a block flow diagram for a configurable logic 500 in accordance with one embodiment. FIG. 5 illustrates a configurable logic 500 that may be representative of the operations executed by a PE in accordance with one embodiment. As shown in configurable logic 500, configuration information may be received at a switch at block 502. The switch may be configured to establish a first set of connections between a plurality of control units and a plurality of data paths to execute a first process using SIMD processing at block 504. The switch may be configured to establish a second set of connections between the control units and the data paths to execute a second process using MIMD processing at block 506. Each control unit may control execution of a single program instruction, for example.

In one embodiment, each control unit may be configured to control execution of a single program instruction. The program instruction may vary according to different applications.

In one embodiment, the first set of connections may configure switch 404 to connect the control units 1-R and data paths DP 1-S in a first configuration to perform SIMD processing. For example, the first set of connections may connect at least one of the control units to multiple data paths DP 1-S, with the one control unit to control the multiple data paths DP 1-S. In this configuration, for example, each data path DP 1-S may be configured to perform a same set of parallel operations using the data stored in memory 406. This may be suitable for many communication applications, such as performing symbol decoding on orthogonal frequency division (OFDM) carriers. Since similar operations are performed on all carriers, the SIMD processing may result in improved system performance. The embodiments are not limited in this context.

In one embodiment, the second set of connections may configure switch 404 to connect control units 1-R to data paths DP 1-S in a second configuration to perform MIMD processing. For example, the second set of connections may connect multiple control units to multiple data paths, with each control unit to control a single data path. In this configuration, for example, each data path DP 1-S may be configured to a different set of parallel operations using the data stored in memory 406. This may be suitable for many communications applications, such as implementing PHY control state machines, and overall data flow operations such as interleaving and multiplexing. This group comprises heterogeneous low MIPS operations that in some cases need to execute in parallel, and therefore MIMD processing may be implemented to improve system performance. The embodiments are not limited in this context.

The embodiments may be implemented using an architecture that may vary in accordance with any number of factors, such as desired computational rate, power levels, heat tolerances, processing cycle budget, input data rates, output data rates, memory resources, data bus speeds and other performance constraints. For example, one embodiment may be implemented using software executed by a processor, as described previously. In another example, one embodiment may be implemented as dedicated hardware, such as an ASIC, Programmable Logic Device (PLD) or DSP and accompanying hardware structures. In yet another example, one embodiment may be implemented by any combination of programmed general-purpose computer components and custom hardware components. The embodiments are not limited in this context.

The embodiments may have been described in terms of one or more modules. Although an embodiment has been described in terms of “modules” to facilitate description, one or more circuits, components, registers, processors, software subroutines, or any combination thereof could be substituted for one, several, or all of the modules. The embodiments are not limited in this context.

While certain features of the embodiments have been illustrated as described herein, many modifications, substitutions, changes and equivalents will now occur to those skilled in the art. It is, therefore, to be understood that the appended claims are intended to cover all such modifications and changes as fall within the true spirit of the embodiments.

1. An apparatus, comprising:
a memory unit to store data;
a plurality of parallel data paths to process said data;
a plurality of control units to control said data paths; and
a switch to connect said control units to said data paths, said switch to receive configuration information to establish a first set of connections between said control units and said data paths to execute a first process, and a second set of connections between said control units and said data paths to execute a second process.

2. The apparatus of claim 1, wherein each control unit controls execution of a single program instruction.

3. The apparatus of claim 2, wherein said first set of connections connects said control units and said data paths in a first configuration to perform single instruction multiple data processing.

4. The apparatus of claim 2, wherein said first set of connections connect at least one of said plurality of control units to multiple data paths, with said one control unit to control said multiple data paths.

5. The apparatus of claim 4, wherein each data path performs a same set of operations using said data.

6. The apparatus of claim 2, wherein said second set of connections connects said control units to said data paths in a second configuration to perform multiple instruction multiple data processing.

7. The apparatus of claim 2, wherein said second set of connections connect multiple control units to multiple data paths, with each control unit to control a single data path.

8. The apparatus of claim 4, wherein each data path performs a different set of operations using said data.

9. The apparatus of claim 1, further comprising a configuration module to configure said switch to establish said connections in accordance with said configuration information.

10. A system, comprising:
an antenna;
a host processing system;
a configuration module to store configuration information; and
a reconfigurable communication architecture module to receive said configuration information, said reconfigurable communication architecture module to configure itself to perform single instruction multiple data processing in a first configuration to execute a first process, and to perform multiple instruction multiple data processing in a second configuration to execute a second process.

11. The system of claim 10, wherein said reconfiguration communication architecture module comprises:
a plurality of processing elements to execute functions for each process;
a plurality of routing elements to connect said processing elements; and
a plurality of communications mediums to connects said processing elements and said routing elements in a mesh topology.

12. The system of claim 10, wherein one of said processing elements comprises:
a memory unit to store data;
a plurality of parallel data paths to process said data;
a plurality of control units to control said data paths; and
a switch to connect said control units to said data paths, said switch to receive said configuration information to establish a first set of connections between said control units and said data paths to execute said first process, and a second set of connections between said control units and said data paths to execute said second process.

13. The system of claim 12, wherein each control unit controls execution of a single program instruction.

14. The system of claim 13, wherein said first set of connections connect at least one of said plurality of control units to multiple data paths, with said one control unit to control said multiple data paths.

15. The system of claim 13, wherein said second set of connections connect multiple control units to multiple data paths, with each control unit to control a single data path.

16. A method, comprising:
receiving configuration information at a switch; and
configuring said switch to establish a first set of connections between a plurality of control units and a plurality of data paths to execute a first process using single instruction multiple data processing; and
configuring said switch to establish a second set of connections between said control units and said data paths to execute a second process using multiple instruction multiple data processing.

17. The method of claim 16, wherein each control unit controls execution of a single program instruction.

18. The method of claim 17, wherein said first set of connections connect at least one of said plurality of control units to multiple data paths, with said one control unit to control said multiple data paths.

19. The method of claim 17, wherein said second set of connections connect multiple control units to multiple data paths, with each control unit to control a single data path.

20. The method of claim 16, further comprising:
receiving a first set of data;
storing said first set of data in a memory unit; and
processing said first set of data with said data paths using said first set of connections.

21. The method of claim 16, further comprising:
receiving a second set of data;
storing said second set of data in a memory unit; and
processing said second set of data with said data paths using said second set of connections.

22. An article comprising:
a storage medium;
said storage medium including stored instructions that, when executed by a processor, result in receiving configuration information at a switch, configuring said switch to establish a first set of connections between a plurality of control units and a plurality of data paths to execute a first process using single instruction multiple data processing, and configuring said switch to establish a second set of connections between said control units and said data paths to execute a second process using multiple instruction multiple data processing.

23. The article of claim 22, wherein the stored instructions, when executed by a processor, further result in said first set of connections connecting at least one of said plurality of control units to multiple data paths, with said one control unit to control said multiple data paths.

24. The article of claim 22, wherein the stored instructions, when executed by a processor, further result in said second set of connections connecting multiple control units to multiple data paths, with each control unit to control a single data path.
